(19) United States
(12) Patent Application Publication
(10) Pub. No.: US 2016/0086727 A1
(43) Pub. Date: Mar. 24, 2016

(54) ELECTRONIC COMPONENT AND BOARD HAVING THE SAME

(71) Applicant: SAMSUNG ELECTRO-MECHANICS CO., LTD., Suwon-Si (KR)

(72) Inventors: Min Sung CHOI, Suwon-Si (KR); Jae Yeol CHOI, Suwon-Si (KR)

(21) Appl. No.: 14/858,776

(22) Filed: Sep. 18, 2015

(30) Foreign Application Priority Data
Sep. 18, 2014 (KR) 10-2014-0124354

(51) Int. Cl. H01F 27/29; H01F 27/28

(52) U.S. Cl. CPC H01F 27/292; H01F 27/2804; H01F 2027/2809

(57) ABSTRACT

An electronic component and a board having the same are provided. The electronic component includes a multilayer body including a plurality of insulating layers with a bottom surface provided as a mounting surface and a top surface opposing the bottom surface; and external electrodes disposed on opposite end surfaces of the multilayer body in a length direction of the multilayer body. The multilayer body further includes a first protrusion portion disposed on the top surface, and second and third protrusion portions disposed on opposite side surfaces of the multilayer body in a width direction of the multilayer body, and a length of the first protrusion portion in the length direction is shorter than a length of the second and third protrusion portions in the length direction.

### CROSS-REFERENCE TO RELATED APPLICATION

This application claims the priority and benefit of Korean Patent Application No. 10-2014-0124354 filed on Sep. 18, 2014, with the Korean Intellectual Property Office, the disclosure of which is incorporated herein by reference.

### BACKGROUND

The present disclosure relates to an electronic component and a board having the same.

In accordance with the miniaturization, slimming, and multi-functionalization of electronic products, the miniaturization of electronic components has been demanded, and electronic components have also been mounted in a highly integrated manner. In accordance with this trend, spaces between the mounted electronic components have been significantly decreased.

An inductor, an electronic component, is a representative passive element configuring an electronic circuit, together with a resistor and a capacitor, to remove noise therefrom. Such an inductor may be combined with a capacitor, using electromagnetic properties, to constitute a resonance circuit amplifying a signal in a specific frequency band, a filter circuit, or the like.

In addition, a multilayer ceramic capacitor, an electronic component, is a chip type condenser mounted on the printed circuit boards of several types of electronic devices, such as display devices of liquid crystal displays (LCDs), plasma display panels (PDPs), and the like, as well as computers, personal digital assistants (PDAs), cellular phones, and the like, and serving to charge electricity therein or discharge electricity therefrom. Such a multilayer ceramic capacitor (MLCC) may be used as a component in various types of electronic devices, due to advantages thereof such as a small size, high capacitance, and ease of mounting feature.

However, although the electronic component may have a metal can formed to remove radiated noise generated when the electronic component is mounted on the printed circuit board, there are problems that external electrodes of the electronic component may be in contact with the metal can and may be short-circuited by the metal can, and a mounting space of the electronic component may be insufficient.

### SUMMARY

An aspect of the present disclosure may provide an electronic component capable of preventing short-circuits between external electrodes formed on a top surface or on opposite end surfaces of a multilayer body in a length direction of the multilayer body by forming step portions on the top surface or on opposite side surfaces of the multilayer body in a width direction of the multilayer body, and a board having the same.

According to an aspect of the present disclosure, an electronic component may include: a multilayer body including a plurality of insulating layers with a bottom surface provided as a mounting surface and a top surface opposing the bottom surface; and external electrodes disposed on opposite end surfaces of the multilayer body in a length direction of the multilayer body. Here, the multilayer body may further include a first protrusion portion disposed on the top surface, and second and third protrusion portions disposed on opposite side surfaces of the multilayer body in a width direction of the multilayer body, and a length of the first protrusion portion in the length direction may be shorter than a length of the second and third protrusion portions in the length direction.

According to another aspect of the present disclosure, an electronic component may include: a multilayer body including a plurality of insulating layers and internal conductive patterns, with a bottom surface provided as a mounting surface and a top surface opposing the bottom surface; and external electrodes disposed on opposite end surfaces of the multilayer body in a length direction of the multilayer body. Here, the multilayer body may further include a first protection layer disposed on the top surface, and second and third protection layers disposed on opposite side surfaces of the multilayer body in a width direction of the multilayer body, and a length of the first protection layer in the length direction may be the same as a length of the second and third protection layers in the length direction.

According to another aspect of the present disclosure, a board having an electronic component may include: a printed circuit board having a plurality of electrode pads disposed on a surface of the printed circuit board; and an electronic component disposed on the printed circuit board. Here, the electronic component may include a multilayer body including a plurality of insulating layers with a bottom surface provided as a mounting surface and a top surface opposing the bottom surface, and external electrodes disposed on opposite end surfaces of the multilayer body in a length direction of the multilayer body, and the multilayer body may further include a first protrusion portion disposed on the top surface, and second and third protrusion portions disposed on opposite side surfaces of the multilayer body in a width direction of the multilayer body. A length of the first protrusion portion in the length direction may be shorter than a length of the second and third protrusion portions in the length direction.

According to another aspect of the present disclosure, a board having an electronic component may include: a printed circuit board having a plurality of electrode pads disposed on a surface of the printed circuit board; and an electronic component disposed on the printed circuit board. Here, the electronic component may include a multilayer body including a plurality of insulating layers and internal conductive patterns, with a bottom surface provided as a mounting surface and a top surface opposing the bottom surface, and external electrodes disposed on opposite end surfaces of the multilayer body in a length direction of the multilayer body, and the multilayer body may further include a first protrusion portion disposed on the top surface, and second and third protrusion portions disposed on opposite side surfaces of the multilayer body in a width direction of the multilayer body. A length of the first protrusion portion in the length direction may be the same as a length of the second and third protrusion portions in the length direction.

According to another aspect of the present disclosure, an electronic component may include: a multilayer body having top and bottom surfaces opposing each other in a thickness direction of the multilayer body, end surfaces opposing each other in a length direction of the multilayer body, and side surfaces opposing each other in a width direction of the multilayer body, including a plurality of insulating layers and a plurality of conductive patterns, and further including a first protrusion portion protruding from the top surface of the multilayer body and second and third protrusion portions respectively protruding from the opposite side surfaces of the multilayer body; and external electrodes disposed on opposite end surfaces of the multilayer body and extending to the top, bottom, and side surfaces of the multilayer body. A thickness of any one of the first through third protrusions may be greater than a thickness of the external electrodes.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating an electronic component according to an exemplary embodiment in the present disclosure;

FIG. 2 is a perspective view illustrating an exemplary embodiment of a multilayer body among embodiments of the electronic component illustrated in FIG. 1;

FIGS. 3A and 3B are front views of the electronic component of FIG. 1;

FIGS. 4A and 4B are plan views of the electronic component of FIG. 1;

FIGS. 5A through 5C are cross-sectional views of exemplary embodiments of the electronic component illustrated in FIG. 1 taken along a length direction;

FIG. 6 is a perspective view illustrating the electronic component according to an exemplary embodiment in the present disclosure mounted on a board;

FIG. 7 is a perspective view illustrating an electronic component according to another exemplary embodiment in the present disclosure;

FIG. 8 is a perspective view illustrating an exemplary embodiment of a multilayer body among embodiments of the electronic component illustrated in FIG. 7;

FIGS. 9A and 9B are front views of the electronic component of FIG. 7; and

FIG. 10 is a perspective view illustrating the electronic component according to another exemplary embodiment in the present disclosure mounted on a board.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

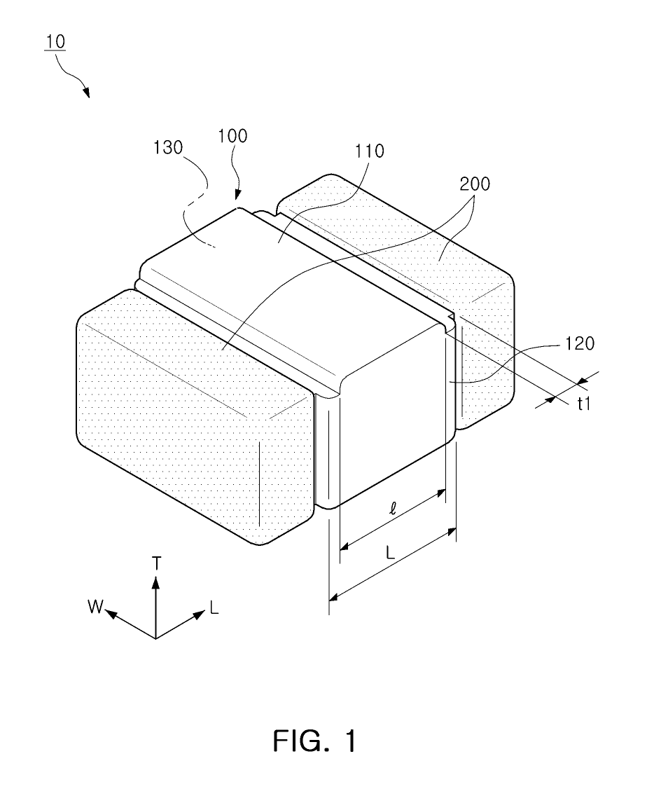

FIG. 1 is a perspective view illustrating an electronic component according to an exemplary embodiment in the present disclosure.

Referring to FIG. 1, an electronic component 10 according to the present disclosure may include a multilayer body 100 and external electrodes 200.

The multilayer body 100 may be formed by stacking a plurality of insulating layers. The plurality of insulating layers in the multilayer body 100 may be in a sintered state. The plurality of insulating layers may be integrated with each other so that boundaries between adjacent insulating layers are not readily apparent without the use of a scanning electron microscope (SEM).

Directions of the multilayer body 100 will hereinafter be defined in order to clearly describe an exemplary embodiment in the present disclosure. L, W and T directions shown in FIG. 1 refer to a length direction, a width direction, and a thickness direction, respectively. In addition, the multilayer body 100 may have a bottom surface provided as a mounting surface, a top surface opposing the bottom surface, two end surfaces in a length direction, and two side surfaces in a width direction.

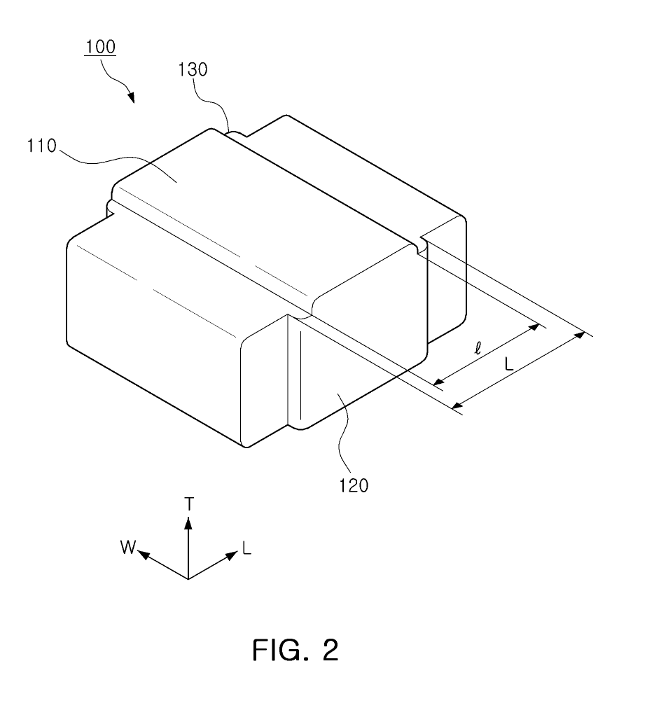

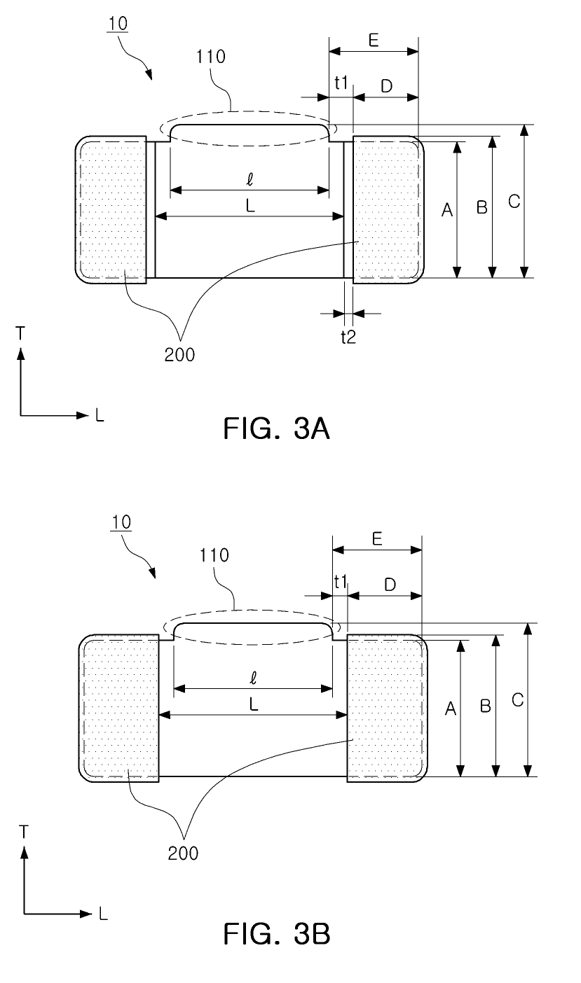

FIG. 2 is a perspective view illustrating an exemplary embodiment of the multilayer body 100 among embodiments of the electronic component 10 illustrated in FIG. 1. FIGS. 3A and 3B are front views of the electronic component 10 of FIG. 1.

Referring to FIGS. 1 through 3B, the multilayer body 100 may include a first protrusion portion 110 disposed on a top surface of the multilayer body 100, and second and third protrusion portions 120 and 130 disposed on opposite side surfaces of the multilayer body 100 in a width direction of the multilayer body.

The first protrusion portion 110 may be disposed in a center of the multilayer body 100 in a length direction of the multilayer body 100. Similarly, the second and third protrusion portions 120 and 130 may also be disposed in the center of the multilayer body 100 in the length direction. However, positions of the first to third protrusion portions 110, 120, and 130 are limited to those described above.

In the multilayer body 100, a length l of the first protrusion portion 110 may be shorter than a length L of the second and third protrusion portions 120 and 130 in the length direction of the multilayer body 100.

The first to third protrusion portions 110, 120, and 130 may not directly contribute to capacitance formation and may serve as auxiliary layers for preventing a plating solution penetration phenomenon occurring during a plating process.

As a result, the first to third protrusion parts 110, 120, and 130 may correspond to first to third protection layers, respectively.

Referring again to FIG. 1, the external electrodes 200 may be disposed on opposite end surfaces of the multilayer body 100 in the length direction.

The external electrodes 200 may contain one or more selected from a group consisting of silver (Ag), platinum (Pt), copper (Cu), and palladium (Pd).

The external electrodes 200 will hereinafter be described in further detail. The external electrodes 200 may be formed to be extended from opposite end surfaces of the multilayer body 100 in the length direction to the top surface thereof.

In this case, since the length l of the first protrusion portion 110 is shorter than the length L of the second and third protrusion portions 120 and 130 in the length direction of the multilayer body 100, the external electrodes 200 formed on the top surface and the first protrusion portion 110 are spaced apart from each other by a difference t1, so as not to be in direct contact with each other.

The external electrodes 200 may be disposed to be extended to opposite side surfaces of the multilayer body 100 in the width direction. Further, the external electrodes 200 may be disposed to be extended from opposite end surfaces of the multilayer body 100 in the length direction onto a bottom surface of the multilayer body 100.

Therefore, in the electronic component according to the present disclosure, the external electrodes 200 may be coated on portions of the multilayer body 100 except for the first to third protrusion portions 110 to 130, in detail, opposite end surfaces of the multilayer body 100 in the length direction, opposite side surfaces of the multilayer body 100 in the width direction, and the top and bottom surfaces of the multilayer body 100.

Referring to FIGS. 3A and 3B, a length A of the multilayer body 100 in a thickness direction of the multilayer body 100, a length B of the external electrode 200 in the thickness direction of the multilayer body 100, and a distance C from the bottom surface of the multilayer body 100 to the first protrusion portion 110 in the thickness direction may have a relationship of A<B<C. Each of the lengths A, B, and C is defined with reference to the bottom surface of the multilayer body 100.

In detail, the relationship of B<C is satisfied, whereby short-circuits between a metal can formed on the top surface and external electrodes may be prevented.

Next, the external electrodes 200 formed to be extended to opposite side surfaces of the multilayer body 100 in the width direction will be described in detail.

In a case of FIG. 3A, the external electrodes 200 may be disposed to be extended to opposite side surfaces of the multilayer body 100 in the width direction and may be disposed to be spaced apart from opposite end surfaces of the second and third protrusion portions 120 and 130 in the length direction of the multilayer body 100 by a predetermined distance t2.

Alternatively, in a case of FIG. 3B, the external electrodes 200 may be extended to opposite end surfaces of the second and third protrusion portions 120 and 130 in the length direction of the multilayer body 100, on opposite side surfaces of the multilayer body 100 in the width direction. In detail, the external electrodes 200 and the second and third protrusion portions 120 and 130 may be in contact with each other.

Here, in the respective cases, the external electrode 200 disposed on the top surface may be spaced apart from the first protrusion portion 110 by a predetermined distance t1 (i.e., D<E, in which D is a distance from an edge of the portion of the external electrode 200 formed on the top surface of the multilayer body 100 to an end surface of the multilayer body 100 in the length direction and E is a distance from the first protrusion portion 110 to the end surface of the multilayer body 100 in the length direction), and a value of t1 in the case of FIG. 3A may be larger than that in the case of FIG. 3B. The reason is that in the case of FIG. 3A, the external electrodes 200 are disposed to be spaced apart from opposite end surfaces of the second and third protrusion portions 120 and 130 in the length direction of the multilayer body 100 by a predetermined distance t2.

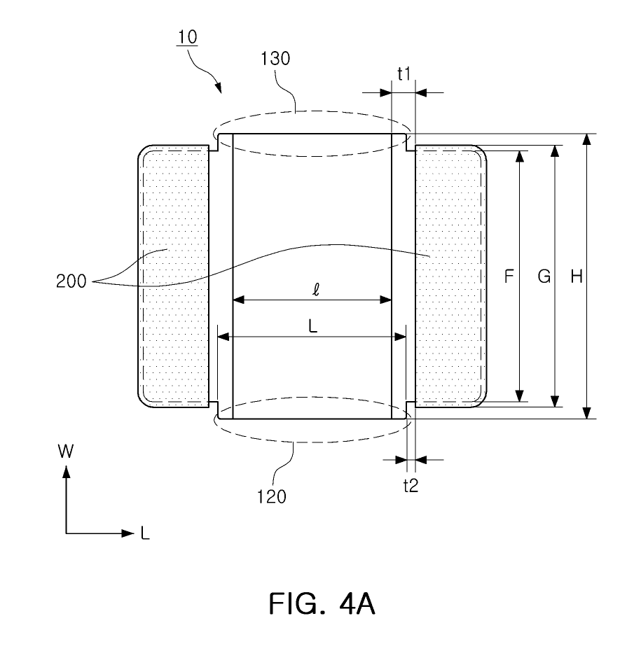

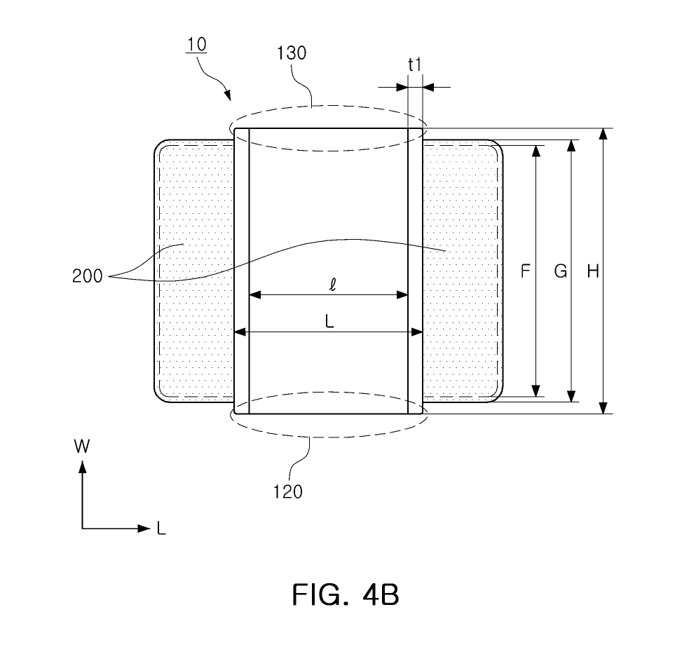

FIGS. 4A and 4B are plan views of the electronic component of FIG. 1.

Similarly to those described in FIGS. 3A and 3B, the external electrodes 200 of the electronic components illustrated in FIGS. 4A and 4B extended from opposite side surfaces of the multilayer body 100 in the width direction, and protrusion portions may have different lengths.

Referring to FIGS. 4A and 4B, as described above, the length l of the first protrusion portion 110 may be shorter than the length L of the second and third protrusion portions 120 and 130 in the length direction of the multilayer body 100.

In addition, a length F of the multilayer body 100 in the width direction, a length G of the external electrode 200 in the width direction of the multilayer body 100, and a distance H from the second protrusion portion 120 to the third protrusion portion 130 in the width direction of the multilayer body 100 may satisfy F<G<H.

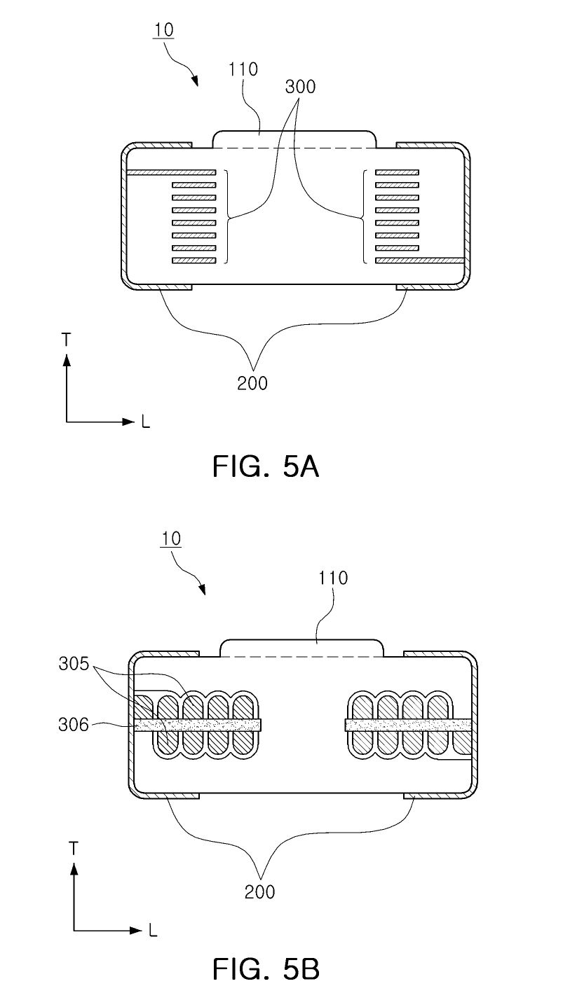

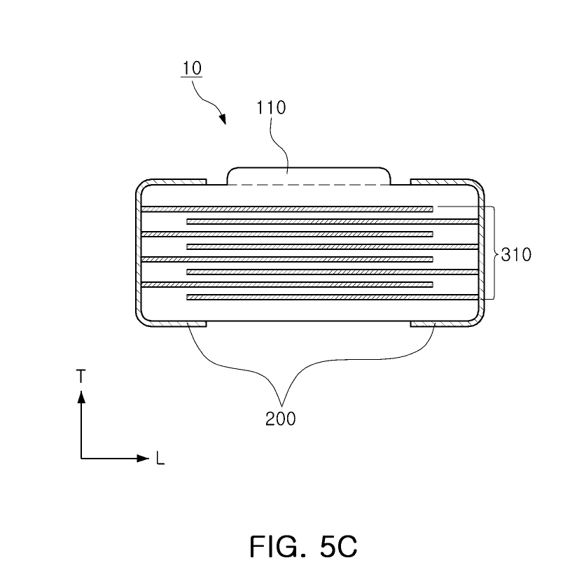

FIGS. 5A through 5C are views of exemplary embodiments of a cross-section of the electronic component illustrated in FIG. 1 taken in a length direction.

Referring to FIG. 5A, an exemplary embodiment of the electronic component according to the present disclosure may be a multilayer inductor.

The plurality of insulating layers included in the multilayer body 100 may be formed of a complex magnetic material including dielectric and ferrite components known in the art, such as an Al₂O₃-based dielectric material, an Mn—Zn-based ferrite, an Ni—Zn-based ferrite, an Ni—Zn—Cu-based ferrite, an Mn—Mg-based ferrite, a Ba-based ferrite, Li-based ferrite, or the like. However, the material of the insulating layer is not limited thereto, and any material exhibiting magnetic properties may be included without being limited.

In addition, the electronic component according to the present disclosure may further include internal coil portions 300 having internal conductive patterns disposed on the plurality of insulating layers.

The multilayer body 100 may be formed by stacking the plurality of insulating layers on which the internal conductive patterns are formed. In this case, the internal conductive patterns may be electrically connected to each other through via holes in the multilayer body 100 to form a single internal coil portion 300. As a result, a target level of inductance may be implemented. In addition, the internal coil portions 300 may be electrically connected to the external electrodes 200 through a plurality of lead parts.

The internal conductive patterns may be formed by printing a conductive paste containing a conductive metal. The conductive metal is not particularly limited as long as it is a metal having excellent electrical conductivity. For example, the conductive metal may be one of silver (Ag), palladium (Pd), aluminum (Al), nickel (Ni), titanium (Ti), gold (Au), copper (Cu), platinum (Pt), and the like, or a mixture thereof.

Referring to FIG. 5B, an exemplary embodiment of the electronic component according to the present disclosure may be a thin film type inductor.

Here, the thin film type inductor may include the multilayer body 100, and internal coil portions 305 embedded in the multilayer body 100.

A plurality of insulating layers included the thin film type inductor according to an exemplary embodiment in the present disclosure may include ferrite or magnetic metal particles, but are not necessarily limited thereto. For example, the insulating layer may include any material without being limited as long as it shows magnetic property.

The magnetic metal particles may be formed of an alloy containing one or more selected from a group consisting of iron (Fe), silicon (Si), chromium (Cr), aluminum (Al), and nickel (Ni). For example, the magnetic metal particles may include Fe—Si—B—Cr-based amorphous metal particles, but are not necessarily limited thereto.

The magnetic metal particles may be included in an epoxy resin or a polymer such as polyimide, or the like in diffused form.

The insulating substrates 306 disposed in the multilayer body 100 may be formed of, for example, a polypropylene glycol (PPG) substrate, a ferrite substrate, a metal-based soft magnetism substrate, or the like.

The insulating substrate 306 may have a hole formed to penetrate through a central portion thereof. The hole may be filled with a magnetic material such as ferrite, a magnetic metal particle, or the like, to form a core part. As the core part filled with the magnetic material is formed, a level of inductance L may be increased.

The internal coil portion 305 having a coil shaped pattern may be formed on a surface of the insulating substrate 306, and may also be formed on another surface of the insulating substrate 306.

The internal coil portion 305 may have a coil pattern formed in a spiral shape, and the internal coil portions 305 formed on a surface of the insulating substrate 306 and another surface of the insulating substrate 306 may be electrically connected to each other by via electrodes (not illustrated) formed in the insulating substrate 305.

The internal coil portion 305 and the via electrodes (not illustrated) may be formed of a metal having excellent electrical conductivity, for example, silver (Ag), palladium (Pd), aluminum (Al), nickel (Ni), titanium (Ti), gold (Au), copper (Cu), platinum (Pt), or alloys thereof.

One end portion of the internal coil portion 305 formed on a surface of the insulating substrate 306 may be exposed to one end surface of the multilayer body 100 in the length direction, and another end portion of the internal coil portion 305 formed on another surface of the insulating substrate 306 may be exposed to the other end surface of the multilayer body 100 in the length direction.

Referring to FIG. 5C, an exemplary embodiment of the electronic component according to the present disclosure may be a capacitor. However, an exemplary embodiment of the electronic component according to the present disclosure will be described in FIG. 5C and below as a multilayer ceramic capacitor, but the electronic component according to the present disclosure is not limited thereto.

Referring to FIG. 5C, the plurality of insulating layers included in the multilayer body 100 may be dielectric, and in detail, may include a ceramic powder having a high dielectric constant, for example, a barium titanate (BaTiO₃)-based or a strontium titanate (SrTiO₃)-based powder.

In addition, the electronic component according to the present disclosure may further include active layers 310 having a plurality of internal conductive patterns which are alternately disposed on the plurality of insulating layers.

The internal conductive patterns which are alternately disposed may have different polarities, may be formed to be alternatively exposed through opposite end surfaces of the multilayer body in a stacking direction of the insulating layers by printing conductive paste including a conductive metal on the insulating layers to a predetermined thickness, and may be electrically insulated from each other by the insulating layer disposed therebetween.

The plurality of internal conductive patterns included in the active layers 310 may be alternately exposed through opposite end surfaces of the multilayer body 100 in the length direction, and exposed portions of the internal conductive patterns may be electrically connected to the external electrodes 200, respectively.

Thus, when a voltage is applied to the external electrodes 200, charges are accumulated between the internal conductive patterns opposing each other. In this case, capacitance of the electronic component may be in proportion to an area of a region in which the internal conductive patterns are overlapped with each other on the active layers 310.

A thickness of the internal conductor pattern may be determined depending on an application of the electronic component. For example, the thickness of the internal conductor pattern may be determined to be within the range of 0.2 to 1.0 μm in consideration of a size of the multilayer body 100. However, the present disclosure is not limited thereto.

In addition, the conductive metal included in the conductive paste forming the internal conductive patterns may be nickel (Ni), copper (Cu), palladium (Pd), or alloys thereof. However, the present disclosure is not limited thereto.

In addition, as a method of printing the conductive paste, a screen printing method, a gravure printing method, or the like, may be used. However, the present disclosure is not limited thereto.

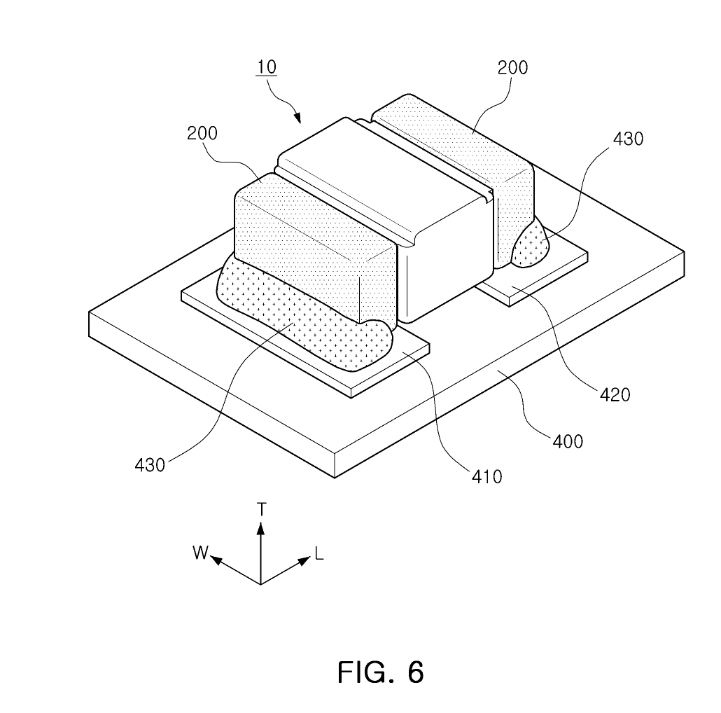

FIG. 6 is a perspective view illustrating the electronic component 10 according to an exemplary embodiment in the present disclosure mounted on a board.

Meanwhile, referring to FIG. 6, a mounting board 400 of the electronic component 10 may include a printed circuit board 400 on which the electronic component 10 is horizontally mounted, and first and second electrode pads 410 and 420 are disposed on a top surface of the printed circuit board 400 to face each other diagonally on the basis of the multilayer body 100.

In this case, in the electronic component 10 according to the present disclosure, the external electrodes 200 disposed on the bottom surface of the multilayer body 100 may be electrically connected to the printed circuit board 400 by solders 430 in a state in which the external electrodes 200 are disposed on the first and second electrode pads 410 and 420 to be in contact with the first and second electrode pads 410 and 420, respectively.

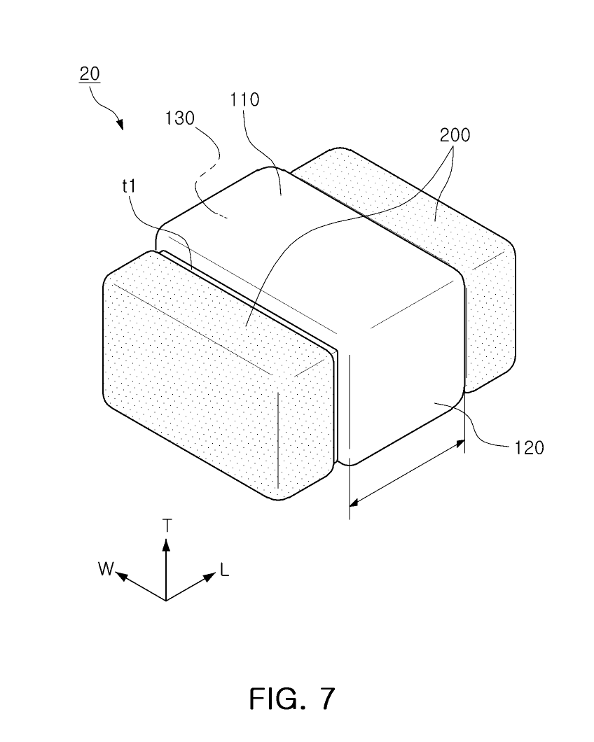

FIG. 7 is a perspective view illustrating an electronic component according to another exemplary embodiment in the present disclosure.

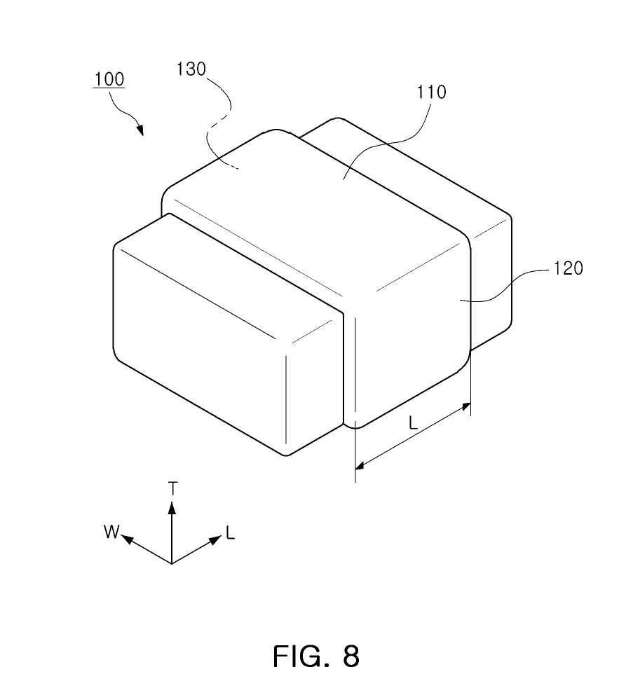

FIG. 8 is a perspective view illustrating an exemplary embodiment of the multilayer body 100 among embodiments of the electronic component illustrated in FIG. 7.

Hereinafter, descriptions overlapped with those of FIGS. 1 through 6 will be omitted.

Referring to FIGS. 7 and 8, the electronic component according to another exemplary embodiment in the present disclosure may include a multilayer body 100 and external electrodes 200.

The multilayer body 100 may include a capacitance formation portion having a plurality of insulating layers on which internal conductive patterns are disposed.

In addition, the multilayer body 100 may further include a first protection layer 110 disposed on the top surface and second and third protection layers 120 and 130 disposed on opposite side surfaces of the multilayer body 100 in a width direction of the multilayer body.

In this case, a length of the first protection layer 110 in a length direction of the multilayer body 100 and a length of the second and third protection layers 120 and 130 in the length direction of the multilayer body 100 are L, which may be the same as each other.

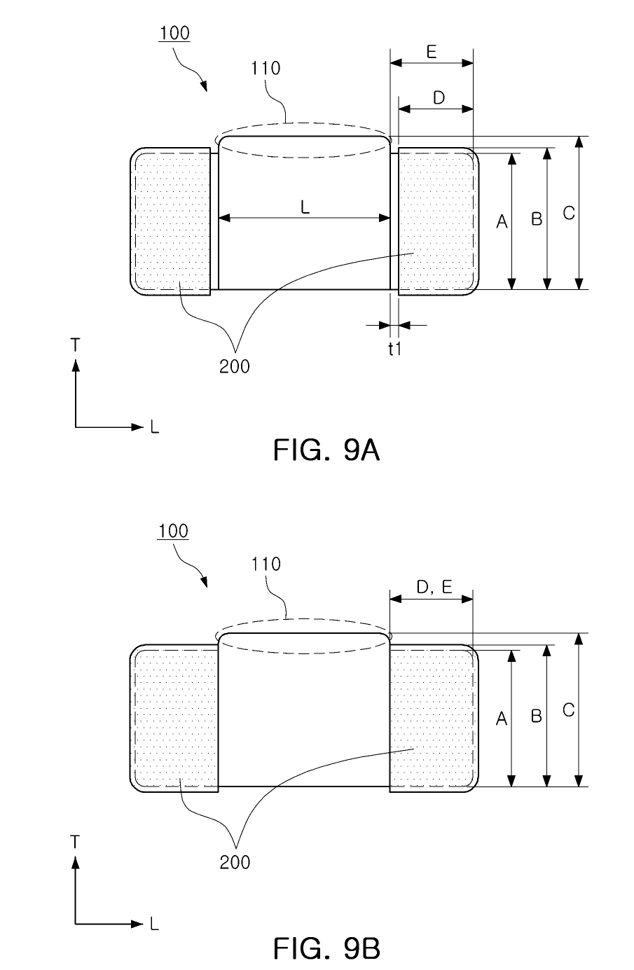

FIGS. 9A and 9B are front views of the electronic component of FIG. 7.

Referring to FIGS. 9A and 9B, the external electrodes 200 may be disposed to be extended from opposite end surfaces of the multilayer body 100 in the length direction to the top surface.

In this case, referring to FIG. 9A, the external electrodes 200 may be disposed to be spaced apart from opposite end surfaces of the first protection layer 110 in the length direction of the multilayer body by a predetermined distance t1. In this case, the external electrodes 200 may also be formed to be extended to opposite side surfaces of the multilayer body 100 in the width direction, but may be spaced apart from the second and third protection layers 120 and 130 by a distance t1 (D<E, in which D is a distance from an edge of the portion of the external electrode 200 formed on the top surface or side surfaces of the multilayer body 100 to an end surface of the multilayer body 100 in the length direction and E is a distance from one of the first through third protrusion portions 110 through 130 to the end surface of the multilayer body 100 in the length direction).

In addition, referring to FIG. 9B, the external electrodes 200 may be formed to be extended from opposite end surfaces of the multilayer body 100 in the length direction to the first protection layer 110. In this case, the external electrodes 200 may also be extended to opposite side surfaces of the multilayer body 100 in the width direction to be in contact with the second and third protection layers 120 and 130 (D=E).

In detail, the electronic component according to another exemplary embodiment in the present disclosure may satisfy D<=E.

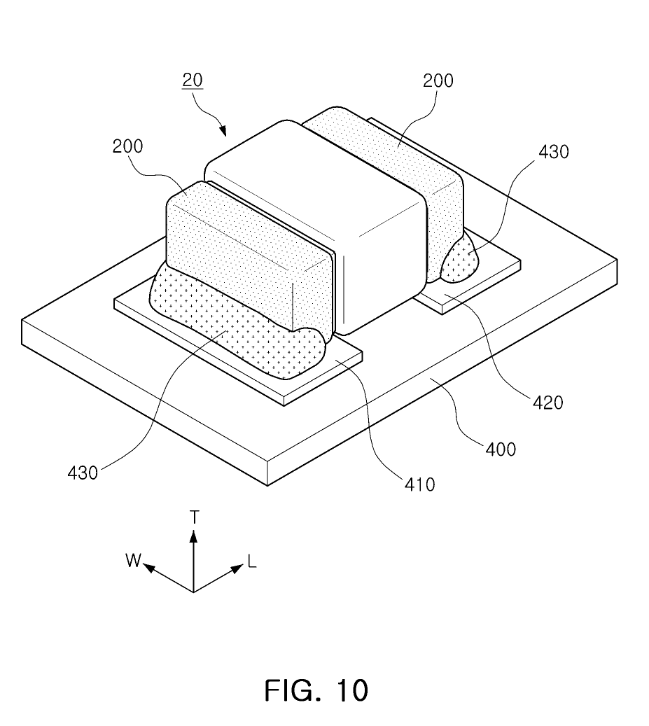

FIG. 10 is a perspective view illustrating the electronic component 20 according to another exemplary embodiment in the present disclosure mounted on a board.

Referring to FIG. 10, in the electronic component 20, the external electrodes 200 disposed on the bottom surface of the multilayer body 100 may be electrically connected to the printed circuit board 400 by the solders 430 in a state in which the external electrodes 200 are disposed on the first and second electrode pads 410 and 420 to be in contact with the first and second electrode pads 410 and 420, respectively.

In this case, in the electronic component 20 according to another exemplary embodiment in the present disclosure, the length of the first protection layer 110 in the length direction of the multilayer body 100 and the length of the second and third protection layers 120 and 130 in the length direction of the multilayer body 100 are L (See FIG. 7), which may be the same as each other.

As set forth above, according to exemplary embodiments in the present disclosure, the electronic component and the board having the same may prevent short-circuits from occurring between the metal can and the external electrodes, and the electronic component is miniaturized, whereby a sufficient space in which the electronic component may be mounted may be secured.

Further, a volume of the multilayer body may be increased, whereby characteristics of the electronic component may be improved.

While exemplary embodiments have been shown and described above, it will be apparent to those skilled in the art that modifications and variations could be made without departing from the scope of the present invention as defined by the appended claims.

What is claimed is:

1. An electronic component comprising:
a multilayer body including a plurality of insulating layers with a bottom surface provided as amounting surface and a top surface opposing the bottom surface; and
external electrodes disposed on opposite end surfaces of the multilayer body in a length direction of the multilayer body,
wherein the multilayer body further includes a first protrusion portion disposed on the top surface, and second and third protrusion portions disposed on opposite side surfaces of the multilayer body in a width direction of the multilayer body, and
a length of the first protrusion portion in the length direction is shorter than a length of the second and third protrusion portions in the length direction.

2. The electronic component of claim 1, wherein the external electrodes extend from the opposite end surfaces of the multilayer body in the length direction to the top surface, and are spaced apart from the first protrusion portion.

3. The electronic component of claim 1, wherein the external electrodes extend from the opposite end surfaces of the multilayer body in the length direction to opposite end surfaces of the second and third protrusion portions in the length direction.

4. The electronic component of claim 1, wherein the external electrodes extend to the opposite side surfaces of the multilayer body in the width direction, and are spaced apart from opposite end surfaces of the second and third protrusion portions in the length direction.

5. The electronic component of claim 1, wherein the external electrodes extend from the opposite end surfaces of the multilayer body in the length direction to the bottom surface of the multilayer body.

6. The electronic component of claim 1, wherein at least one of the first to third protrusion portions is disposed in a center of the multilayer body in the length direction.

7. The electronic component of claim 1, wherein a length of the first protrusion portion in a thickness direction of the multilayer body is longer than a length of the external electrode disposed on the top surface in the thickness direction.

8. The electronic component of claim 1, wherein a distance from the second protrusion portion to the third protrusion portion in the width direction is greater than a distance between the external electrodes disposed on the opposite side surfaces of the multilayer body in the width direction.

9. An electronic component comprising:
a multilayer body including a plurality of insulating layers and internal conductive patterns, with a bottom surface provided as a mounting surface and a top surface opposing the bottom surface; and
external electrodes disposed on opposite end surfaces of the multilayer body in a length direction of the multilayer body,
wherein the multilayer body further includes a first protection layer disposed on the top surface, and second and third protection layers disposed on opposite side surfaces of the multilayer body in a width direction of the multilayer body, and
a length of the first protection layer in the length direction is the same as a length of the second and third protection layers.

10. The electronic component of claim 9, wherein the external electrodes extend from the opposite end surfaces of the multilayer body in the length direction to the top surface, and are spaced apart from the first protection layer.

11. The electronic component of claim 9, wherein the external electrodes extend from the opposite end surfaces of the multilayer body in the length direction to opposite end surfaces of the second and third protection layers in the length direction.

12. The electronic component of claim 9, further comprising internal coil portions having the internal conductive patterns disposed on the plurality of insulating layers.

13. The electronic component of claim 9, further comprising internal coil portions embedded in the multilayer body,
wherein the multilayer body further includes a core layer having the internal coil portions.

14. The electronic component of claim 9, wherein the internal conductive patterns are alternately disposed on the plurality of insulating layers.

15. The electronic component of claim 9, wherein the external electrodes extend from the opposite end surfaces of the multilayer body in the length direction to the bottom surface of the multilayer body.

16. An electronic component comprising:
a multilayer body having top and bottom surfaces opposing each other in a thickness direction of the multilayer body, end surfaces opposing each other in a length direction of the multilayer body, and side surfaces opposing each other in a width direction of the multilayer body, including a plurality of insulating layers and a plurality of conductive patterns, and further including a first protrusion portion protruding from the top surface of the multilayer body and second and third protrusion portions respectively protruding from the opposite side surfaces of the multilayer body; and
external electrodes disposed on the opposite end surfaces of the multilayer body and extending to the top, bottom, and side surfaces of the multilayer body,
wherein a thickness of any one of the first through third protrusions is greater than a thickness of the external electrodes.

17. The electronic component of claim 16, wherein the external electrodes directly contact one of the first through third protrusions.

18. The electronic component of claim 16, wherein the external electrodes do not directly contact the first protrusion and directly contact the second and third protrusions.

19. The electronic component of claim 16, wherein a length of the first protrusion in the length direction is different from a length of the second and third protrusions in the length direction.

20. The electronic component of claim 16, wherein in a region between the external electrodes on the bottom surface, no protrusion is formed.
